(19) United States
(12) Patent Application Publication
(10) Pub. No.: US 2018/0144063 A1
(43) Pub. Date: May 24, 2018

(54) METHOD FOR ASSOCIATING APPLICATION SERVICE INFORMATION, AND APPLICATION ASSOCIATION PLATFORM SERVER AND CLIENT

(71) Applicant: TENCENT TECHNOLOGY (SHENZHEN) COMPANY LIMITED, Shenzhen City, Guangdong (CN)

(72) Inventors: Zhang CHEN, Shenzhen City (CN); Yuan FANG, Shenzhen (CN); Haiyu LIU, Shenzhen City (CN); Bin QIU, Shenzhen City (CN); Yuanfang LYU, Shenzhen City (CN); Fang YUAN, Shenzhen City (CN)

(73) Assignee: TENCENT TECHNOLOGY (SHENZHEN) COMPANY LIMITED, Shenzhen City, Guangdong (CN)

(21) Appl. No.: 15/572,697

(22) PCT Filed: May 26, 2016
(86) PCT No.: PCT/CN2016/083402

§ 371 Date: Nov. 8, 2017

(30) Foreign Application Priority Data
Aug. 14, 2015 (CN) 201510501246.1

(51) Int. Cl. G06F 17/30; H04W 4/30; H04L 29/08

(52) U.S. Cl. CPC G06F 17/30964; H04W 4/30; H04L 67/10; G06F 17/30864; H04L 67/32

(57) ABSTRACT

The present disclosure discloses a method for associating application service information, including: receiving, by an application association platform client, an entered trigger instruction, generating a presentation request according to the trigger instruction, and sending the presentation request to an application association platform server; receiving new service information returned by the application association platform server and application links associated with data segments in the new service information, and displaying the new service information and the associated application links; and receiving a jump instruction that triggers an application link in the new service information, jumping from a current interface to an application corresponding to the triggered application link, and displaying, in the application, an interaction interface corresponding to the triggered new service information. The present disclosure further discloses an application association platform server and client.

### RELATED APPLICATION

This application is a National Stage of International Application No. PCT/CN2016/083402, filed on May 26, 2016, which claims priority to Chinese Patent Application No. 201510501246.1, entitled “METHOD FOR ASSOCIATING APPLICATION SERVICE INFORMATION, AND APPLICATION ASSOCIATION PLATFORM SERVER AND CLIENT” filed on Aug. 14, 2015 in the State Intellectual Property Office, the contents of all of which are incorporated herein by reference in their entirety.

### FIELD

Apparatuses, methods, devices and systems consistent with the present disclosure relate to the field of Internet technologies, and in particular, to a method for associating application service information, and an application association platform server and client.

### DESCRIPTION OF RELATED ART

Currently, smart terminals may provide various applications, and a user can obtain, from the various applications, service information needed by the user. For example, the user can download novels, watch videos, look for nearby restaurants, book flight tickets, obtain coupons, and download ringtones by using various applications to meet requirements in daily life and work of the user. However, because there are a huge variety and a large quantity of applications, to find service information, the user needs to know in advance which applications are related to the category of the service information that the user is to find, and selects one of the applications to make a search. For example, when the user needs to find a video, the user needs to make a search in a video player application. When the user needs to find a novel, the user needs to make a search in a reader application. If an application selected by the user has not been installed on the terminal, the user needs to first download the application from an application downloading platform and then search the application for service information needed by the user. If the needed service information is not found in the application selected by the user, the user further needs to download and install another application to make a search again until the user finds the service information needed by the user. This definitely increases the complexity and consumes time of operations.

### SUMMARY

According to one or more exemplary embodiments, there is provided a method for associating application service information, an application association platform server and an application association platform client, so as to simplify an operation process of searching an application for service information and reduce a search time. According to one or more exemplary embodiments, there is provided a method for associating application service information, comprising: receiving, by an application association platform server, service information sent by an associated-application server, the service information comprising at least one piece of service information obtained from each application by the associated-application server according to an information association variable in a preset application association protocol; dividing each of the at least one piece of service information into a plurality of data segments according to the information association variable; receiving a presentation request sent by an application association platform client, and obtaining a keyword according to the presentation request; searching for all data segments that match the keyword and an application link that is associated with each data segment, and reassembling the found data segments into new service information according to the application association protocol; and sending the new service information and application links associated with the data segments in the new service information to the application association platform client for display. According to one or more exemplary embodiments, there is provided a method for associating application service information, comprising: receiving, by an application association platform client, an entered trigger instruction, generating a presentation request according to the trigger instruction, and sending the presentation request to an application association platform server; receiving new service information returned by the application association platform server and application links associated with data segments in the new service information, and displaying the new service information and the associated application links; and receiving a jump instruction that triggers an application link in the new service information, jumping from a current interface to an application corresponding to the triggered application link, and displaying, in the application, an interaction interface corresponding to the triggered new service information.

According to one or more exemplary embodiments, there is provided an application association platform server, comprising: a first network module configured to receive service information sent by an associated-application server, the service information comprising at least one piece of service information obtained from each application by the associated-application server according to an information association variable in a preset application association protocol; a structuration module configured to divide each piece of service information into a plurality of data segments according to the information association variable; a second network module configured to receive a presentation request sent by an application association platform client; a keyword obtaining module configured to obtain a keyword according to the presentation request; and a reassembly module configured to search for all data segments that match the keyword and application links that are associated with each data segment, and to reassemble the found data segments into new service information according to the application association protocol.

In an exemplary embodiment, the second network module is further configured to send the new service information and application links associated with the data segments in the new service information to the application association platform client for display. According to one or more exemplary embodiments, there is provided an application association platform client, comprising: an entry module configured to receive an entered trigger instruction and generate a presentation request according to the trigger instruction; a third network module configured to send the presentation request to an application association platform server and receive new service information returned by the application association platform server and application links associated with data segments in the new service information; a display module configured to display the new service information and the associated application links; and a jump module configured to jump from a current interface to an application corresponding to the triggered application link.

According to one or more exemplary embodiments, the entry module is further configured to receive a jump instruction that triggers an application link in the new service information.

According to one or more exemplary embodiments, the display module is further configured to display, in the application, an interaction interface corresponding to the triggered new service information.

According to one or more exemplary embodiments, there is provided a non-volatile computer readable storage medium storing a program, where the program can cause a computer to perform an operation comprising: receiving service information sent by an associated-application server, the service information comprising at least one piece of service information obtained from each application by the associated-application server according to an information association variable in a preset application association protocol; dividing each piece of service information into a plurality of data segments according to the information association variable; receiving a presentation request sent by an application association platform client, and obtaining a keyword according to the presentation request; searching for all data segments that match the keyword and application links that are associated with each data segment, and reassembling the found data segments into new service information according to the application association protocol; and sending the new service information and application links associated with the data segments in the new service information to the application association platform client for display.

According to one or more exemplary embodiments, there is provided a non-volatile computer readable storage medium storing a program, where the program can cause a computer to perform an operation comprising: receiving an entered trigger instruction, generating a presentation request according to the trigger instruction, and sending the presentation request to an application association platform server; receiving new service information returned by the application association platform server and application links associated with data segments in the new service information, and displaying the new service information and the associated application links; and receiving a jump instruction that triggers an application link in the new service information, jumping from a current interface to an application corresponding to the triggered application link, and displaying, in the application, an interaction interface corresponding to the triggered new service information.

According to one or more exemplary embodiments, there is provided an application association platform server that presets an application association protocol, divides and reassembles service information according to an information association variable specified in the application association protocol, and sends the service information to an application association platform client for display. According to one or more exemplary embodiments, a user may directly find, in the application association platform client, which applications service information needed by the user is specifically on, and thereby simplifying an operation process of searching an application for service information and reducing a search time. According to one or more exemplary embodiments, after an application link displayed on an interface of the application association platform client is triggered, a jump may be directly made from the application association platform client of an application association platform to the triggered application, and navigation to an interaction interface of target service information in the application may be directly performed, thereby implementing a fast jump to the application. Consequently, the user does not need to manually start the application to jump to, thereby further reducing a search time for service information.

### BRIEF DESCRIPTION OF THE DRAWINGS

The above and other aspects will become apparent from the following description of exemplary embodiments, with reference to the accompanying drawings in which

FIG. 1 is a schematic diagram of a running environment for data interactions between an application association platform server, an application association platform client, and an associated-application server according to an exemplary embodiment;

FIG. 2 is a schematic structural diagram of a terminal in which an application association platform client is located according to an exemplary embodiment;

FIG. 3 is a flowchart of a method for associating application service information implemented by an application association platform server according to an exemplary embodiment;

FIG. 4 is a flowchart of a method for associating application service information implemented by an application association platform server according to another exemplary embodiment;

FIG. 5 is a flowchart of a method for associating application service information implemented by an application association platform server according to another exemplary embodiment;

FIG. 6 is a flowchart of a method for associating application service information implemented by an application association platform server according to another exemplary embodiment;

FIG. 7 is a flowchart of a method for associating application service information implemented by an application association platform client according to an exemplary embodiment;

FIG. 8 is a flowchart of a method for associating application service information implemented by an application association platform client according to another exemplary embodiment;

FIG. 9 is a flowchart of a method for associating application service information implemented by an application association platform client according to another exemplary embodiment;

FIG. 10 is a flowchart of a method for associating application service information implemented by an application association platform client according to another exemplary embodiment;

FIG. 11 is a schematic diagram of modules of an application association platform server according to an exemplary embodiment;

FIG. 12 is a schematic diagram of modules of an application association platform client according to an exemplary embodiment;

FIG. 13 is a schematic diagram of division into and reassembly of data segments associated with application service information according to an exemplary embodiment;

FIG. 14a is a schematic diagram of an interaction interface of an application association platform client according to an exemplary embodiment;

FIG. 14b is a schematic diagram of an interaction interface of an application association platform client according to another exemplary embodiment; and

FIG. 15 is a schematic structural diagram of a server according to an exemplary embodiment.

Objective implementation, functional features, and advantages of the present disclosure are further described with reference to the embodiments and the accompanying drawings.

### DESCRIPTION OF EXEMPLARY EMBODIMENTS

It should be understood that, specific embodiments described herein are merely intended to explain the present disclosure instead of limiting the present disclosure.

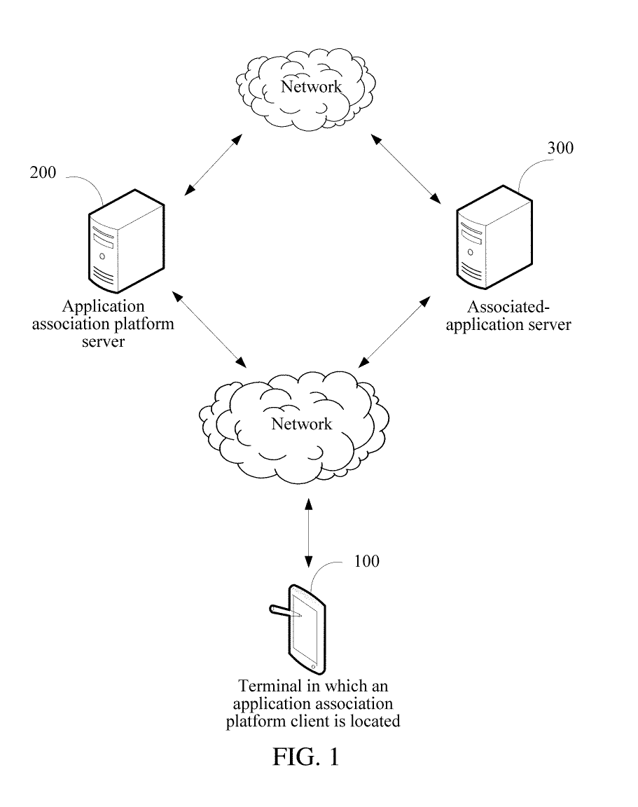

Referring to FIG. 1, an application association platform provided in an exemplary embodiment includes an application association platform server 200 and a terminal 100 in which an application association platform client is installed. The application association platform client may be a browser that supports an application association function or application software corresponding to the application association platform. The terminal 100 in which the application association platform client is located may include a smart phone, a tablet computer, a notebook computer, an all-in-one computer, a network television set, and the like. The terminal 100 in which the application association platform client is located is connected to the application association platform server 200 through a network. According to one or more exemplary embodiments, the application association platform server 200 is also connected to a server 300 of another application, that is, an associated-application server 300. The associated-application server 300 is a server of an application associated with the application association platform. The application association platform server 200 obtains service information of each application or an installation package of each application from the associated-application server 300. The terminal 100 in which the application association platform client is located may download an installation package of another application by using the application association platform server 300. According to one or more exemplary embodiments, after application software is installed, the terminal 100 in which the application association platform client is located may also be connected to the associated-application server 300 by using the application software, and obtain a service from the associated-application server 300.

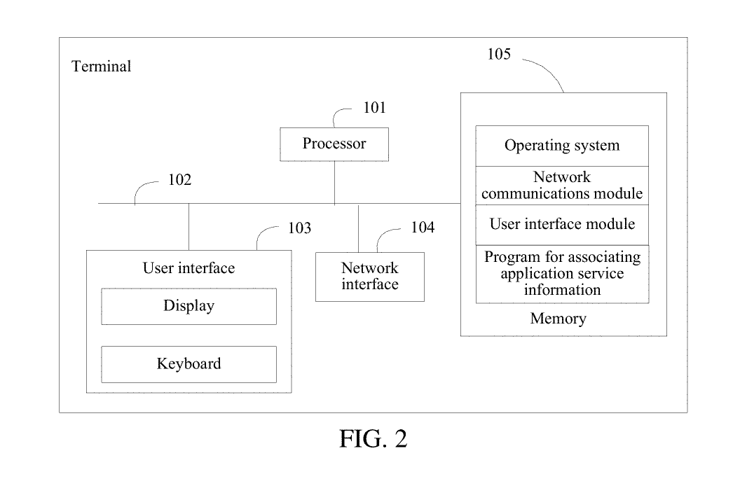

FIG. 2 is a structural diagram of a terminal in which an application association platform client is located according to an exemplary embodiment. The terminal may include: at least one processor 101 such as a CPU, at least one network interface 104, a user interface 103, a memory 105, and at least one communications bus 102. The communications bus 102 is configured to implement connection and communication between these components. In an exemplary embodiment, the user interface 103 may include a display and a keyboard, and may further include a standard wired interface and a wireless interface. In an exemplary embodiment, the network interface 104 may include a standard wired interface and a wireless interface (for example, a WIFI interface). In an exemplary embodiment, the memory 105 may be a high-speed RAM memory, or may be a non-volatile memory, for example, but not limited to, at least one magnetic disk memory. In an exemplary embodiment, the memory 105 may be at least one storage apparatus located far away from the processor 101. In an exemplary embodiment, as a computer storage medium, the memory 105 may further include an operating system, a network communications module, a user interface module, and a program for associating application service information.

According to one or more exemplary embodiments, in the terminal in which the application association platform client is located as shown in FIG. 2, the network interface 104 is mainly configured to connect to a server or another terminal, and perform data communication with the server or another terminal. The user interface 103 is mainly configured to receive a user instruction, and interact with a user. According to one or more exemplary embodiments, the processor 101 may be configured to invoke the program that is for associating application service information and is stored in the memory 105, and perform an operation comprising: receiving an entered trigger instruction through the user interface 103, generating a presentation request according to the trigger instruction, and sending the presentation request to an application association platform server through the network interface 104; receiving, through the network interface 104, new service information returned by the application association platform server and application links associated with data segments in the new service information, and displaying the new service information and the associated application links at the user interface 103; and receiving, through the user interface 103, a jump instruction that triggers an application link in the new service information, jumping from a current interface to an application corresponding to the triggered application link, and displaying, in the application, an interaction interface corresponding to the triggered new service information.

In an exemplary embodiment, the processor 101 may further invoke the program that is for associating application service information and is stored in the memory 105 to perform at least one of the following two operations: (1) receiving, through the user interface 103, a trigger instruction that triggers a search bar, receiving a keyword entered into the search bar, and generating a presentation request that includes the keyword; and (2) receiving, through the user interface 103, a trigger instruction that triggers a recommendation interface, and automatically generating a presentation request in response to that the recommendation interface is entered.

In an exemplary embodiment, the processor 101 may further invoke the program that is for associating application service information and is stored in the memory 105 to perform an operation comprising: determining whether an application corresponding to an application link has been installed in a terminal in which the application association platform client is located.

In an exemplary embodiment, the processor 101 may further invoke the program that is for associating application service information and is stored in the memory 105 to perform at least one of the following two operations: (1) if the application corresponding to the application link has been installed in the terminal, jumping, through the user interface 103, from the current interface to the application corresponding to the triggered application link, and displaying, in the application, the interaction interface corresponding to the triggered new service information; and (2) if the application corresponding to the application link has not been installed in the terminal, jumping, through the user interface 103, from the current interface to an installation package download interface that is in the application association platform client and is for downloading the application corresponding to the triggered application link, or jumping to a web page of the application corresponding to the triggered application link, and displaying, in the web page of the application, the interaction interface corresponding to the triggered new service information. According to one or more exemplary embodiments, in the application association platform client and the terminal in which the application association platform client is located as shown in FIG. 1 and FIG. 2, service information sent by a server and an application link corresponding to a data segment in the service information are displayed on an interface of the application association platform client. In an exemplary embodiment, a user may directly find, in the application association platform client, which applications service information needed by the user is specifically on, thereby simplifying an operation process of searching an application for service information and reducing a search time. In an exemplary embodiment, after the application link displayed on the interface of the application association platform client is triggered, a jump may be directly made from the application association platform client of an application association platform to the triggered application, and navigation to an interaction interface of target service information in the application may be directly performed, thereby implementing a fast jump to the application. Consequently, the user does not need to manually start the application to jump to, thereby further reducing a search time for service information.

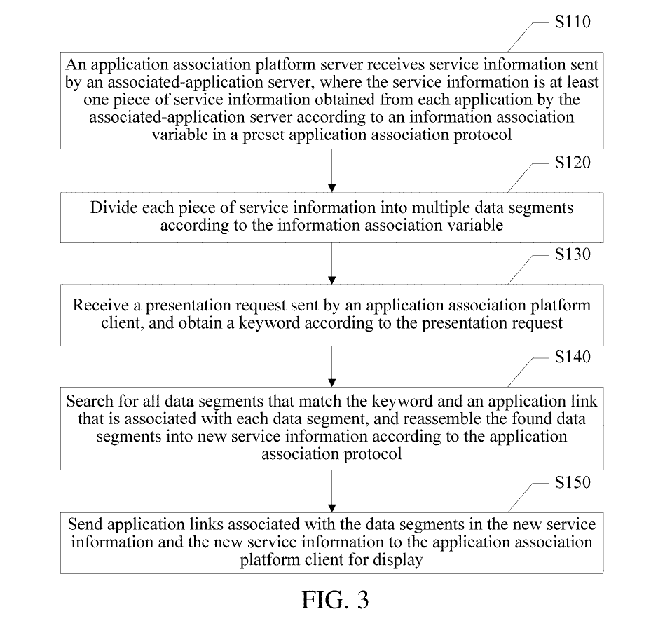

FIG. 3 is a flowchart of a method for associating application service information implemented by an application association platform server according to an exemplary embodiment. The method comprises at least the following operations:

Operation S110: in an exemplary embodiment, the application association platform server receives service information sent by an associated-application server, where the service information comprising at least one piece of service information obtained from each application by the associated-application server according to an information association variable in a preset application association protocol.

In this embodiment, the application association platform server is used to implement the method for associating application service information. The application association platform server can record service information of various applications, and display the service information on the interface of the application association platform client. The server corresponding to various applications is the associated-application server mentioned in this embodiment. An application association protocol is preset between the application association platform server and the associated-application server. The application association protocol includes multiple information association variables, and the information association variables are related to the service information in the applications and include a name, a category, a picture, audio, a video, a keyword, a data and time of creation, last modification and the like involved in the service information. The associated-application server extracts some or all of the service information from the applications according to the information association variables in the application association protocol. The service information includes content corresponding to the information association variables.

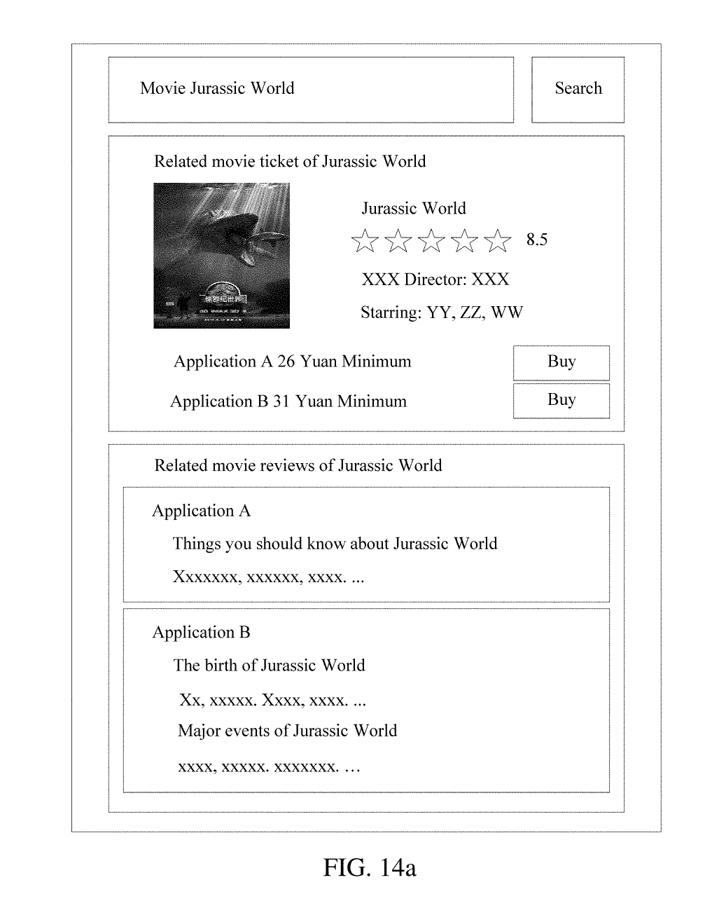

In an exemplary embodiment, an application A includes service information such as “movie tickets”, “movie reviews”, “coupons”, and “videos”, the associated-application server extracts information such as names, synopses, pictures, ticket prices, and ratings from the service information “movie tickets” according to the information association variables in the application association protocol, and further extracts information such as titles and plot synopses from the service information “movie reviews”. Each associated-application server sends the extracted service information to an application association platform, and the service information is associated with an application of the associated-application server. In an exemplary embodiment, as shown in FIG. 13, according to the information association variables such as names, pictures, and videos, the application A provides service information A and service information B to the application association platform, and an application B provides service information A to the application association platform.

Operation S120: in an exemplary embodiment, the application association platform server divides each piece of the received service information into a plurality of data segments according to the information association variable to form structured data segments.

In an exemplary embodiment, during the division, each piece of service information may further be pre-processed. For example, repetitive data is removed, associated data is combined into a same item, and content that violates legal or ethical norms is filtered out. In an exemplary embodiment, as shown in FIG. 13, the service information A provided by the application A is divided into a name A and a picture A, the service information B provided by the application A is divided into a name B, a picture B, and a video B, and the service information A provided by the application B is divided into the name A and a video A. After the service information A provided by the application A and the service information A provided by the application B are divided, there is some repetitive content, that is, the data segment “name A”, and there is associated content, that is, the picture A and the video A that are both associated with the name A. Therefore, in an exemplary embodiment, repetitive data may be removed, and the name A, the picture A, and the video A may be combined into one item.

Operation S130: in an exemplary embodiment, the application association platform server receives a presentation request sent by an application association platform client, and obtains a keyword according to the presentation request.

In an exemplary embodiment, the application association platform client is installed on a terminal in advance. The application association platform client includes a browser or a client that supports an application association function. The browser and the client both support the application association protocol provided by the application association platform.

In an exemplary embodiment, after a user opens the application association platform client on the terminal, the application association platform client may generate a presentation instruction according to search information entered by the user, or the application association platform client initiates a presentation instruction, and sends the presentation request to the application association platform server. If the presentation request is generated according to the search information entered by the user, the presentation request includes a search keyword entered by the user. If the presentation instruction is initiated by the client, the application association platform server may automatically filter out a popular keyword according to search popularity.

Operation S140: in an exemplary embodiment, the application association platform server searches for all data segments that match the keyword and an application link that is associated with each data segment, and reassemble the found data segments into new service information according to the application association protocol.

The application association platform server searches, according to the keyword, for a corresponding data segment and an application link associated with the found data segment.

In an exemplary embodiment, as shown in FIG. 13, all data segments, that is, a name A, a picture A, and a video A, and links of the application A and the application B associated with these data segments are found according to a keyword A.

In an exemplary embodiment, the application association platform server reassembles the obtained data segments according to the application association protocol, to obtain new service information, and forms new interface data by using the new service information and application links associated with the data segments in the new service information.

In an exemplary embodiment, as shown in FIG. 13, the data segments, that is, the name A, the picture A, and the video A in the service information A, an application link application A associated with the name A and the picture A, and an application link application B associated with the name A and the video A are reassembled to form new service information.

Operation S150: in an exemplary embodiment, the application association platform server sends the new service information and the application links associated with the data segments in the new service information to the application association platform client for display.

In an exemplary embodiment, the application association platform server sends the reassembled service information and the related application links together to the application association platform client, and the application association platform client displays the received information on an interaction interface of the application association platform client for users to view.

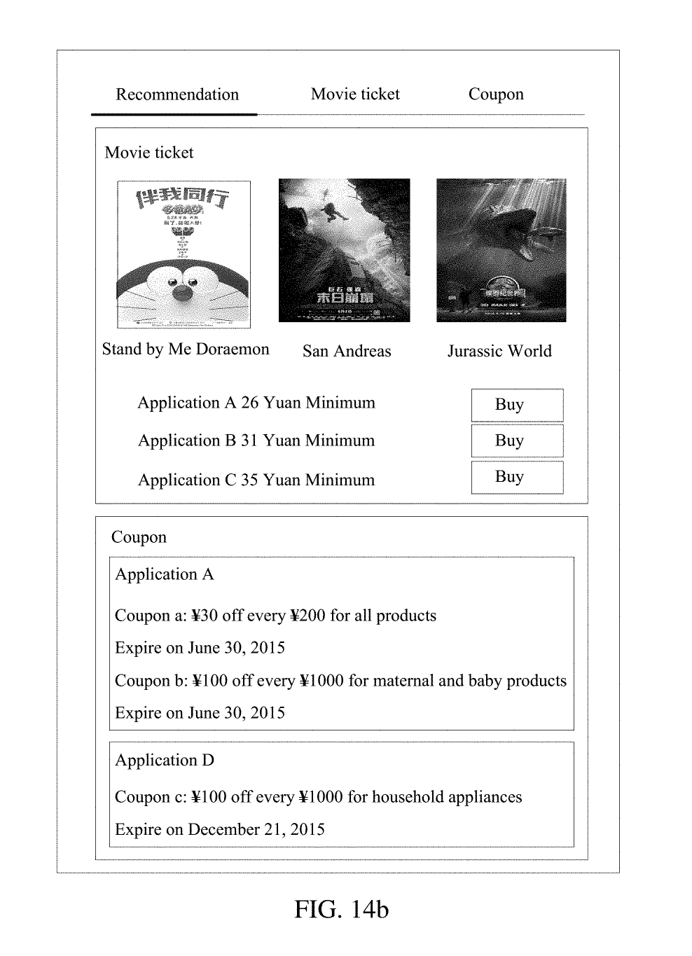

In an exemplary embodiment, as shown in FIG. 14a, a keyword included in a presentation request is “movie Jurassic World”. The corresponding data segments that match with the keyword found by an application association platform include movie synopses, pictures, movie ticket prices and movie reviews in the application A and the application B of Jurassic World, and application links of the application A and the application B associated with these data segments. The application association platform reassembles the found information and displays the information on an interaction interface of the application association platform client. A user may directly find, in the application association platform client, which applications service information needed by the user is specifically on, thereby simplifying an operation process of searching an application for service information and reducing a search time.

In an exemplary embodiment, an application association platform server presets an application association protocol, obtains service information in each application from an associated-application server according to an information association variable specified in the application association protocol, and divides the service information into multiple data segments according to the information association variable in the application association protocol. When a presentation request sent by an application association platform client is received, a corresponding data segment is found according to a keyword included in the presentation request, and the found data segment and an application link corresponding to the data segment are reassembled according to the application association protocol, returned to the application association platform client, and displayed on an interface of the application association platform client by the application association platform client. A user may directly find, in the application association platform client, which applications service information needed by the user is specifically on, thereby simplifying an operation process of searching an application for service information and reducing a search time.

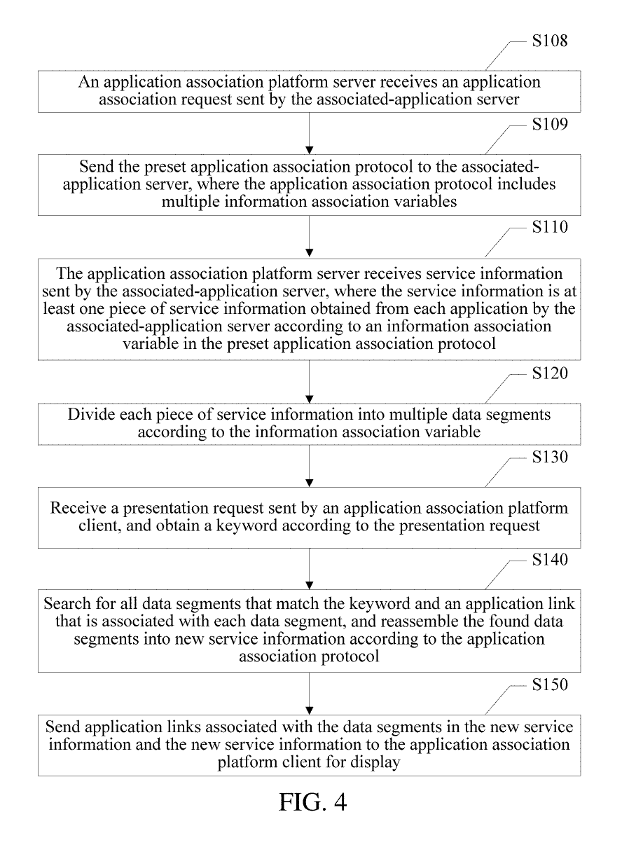

FIG. 4 is a flowchart of a method for associating application service information implemented by an application association platform server according to another exemplary embodiment. This embodiment includes operations of the embodiment shown in FIG. 3, and before step S110, further includes the following operations:

Operation S108: in an exemplary embodiment, the application association platform server receives an application association request sent by the associated-application server.

Operation S109: in an exemplary embodiment, the application association platform server sends a preset application association protocol to the associated-application server, where the application association protocol includes multiple information association variables.

In an exemplary embodiment, the application association platform server generates an application association protocol in advance according to an information association variable entered by a developer. The application association protocol includes multiple information association variables, and the information association variables are related to service information in the applications and include a name, a category, a picture, audio, a video, a keyword, a data and time of creation, last modification and the like involved in the service information. When the associated-application server needs to associate some applications to the application association platform, the associated-application server may actively send an application association request to the application association platform server. After receiving the request, the application association platform server returns the preset application association protocol to the associated-application server. Next, the associated-application server may obtain, according to an information association variable in the application association protocol, information needed by the application association platform server, that is, service information in each application.

In an exemplary embodiment, the application association platform server obtains service information from the associated-application server according to the application association protocol and the information association variable, so that the application association platform server subsequently divides the obtained service information into a plurality of data segments, and associates each application link with a corresponding data segment of the plurality of data segments, so as to facilitate implementation of reassembly of service information.

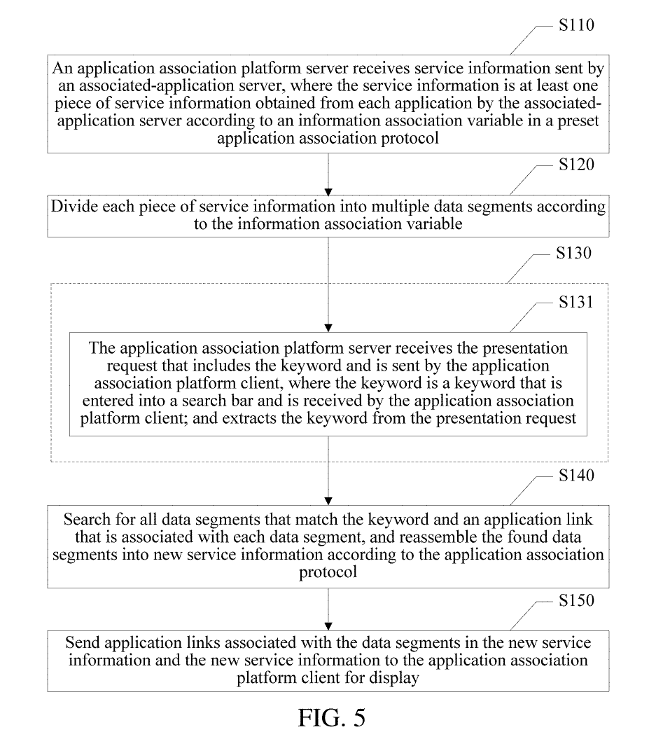

FIG. 5 is a flowchart of a method for associating application service information implemented by an application association platform server according to another exemplary embodiment. This embodiment includes the operations of the embodiment shown in FIG. 3, in which Operation S130 further includes:

Operation S131: In an exemplary embodiment, the application association platform server receives a presentation request that includes a keyword and is sent by the application association platform client, where the keyword is a keyword that is entered into a search bar and is received by the application association platform client; and extracts the keyword from the presentation request.

In an exemplary embodiment, as shown in FIG. 14a, when the user enters a keyword “movie Jurassic World” into a search bar of an interface of the application association platform client, the application association platform client encapsulates the keyword into a presentation request, and sends the presentation request to the application association platform server. Upon receipt of the presentation request, the application association platform server extracts the keyword from the presentation request, and searches for all data segments that match the keyword, including: movie synopses, pictures, movie ticket prices and movie reviews in the application A and the application B of Jurassic World, and an application link corresponding to each data segment, including: application links of the application A and the application B. In an exemplary embodiment, the application association platform server further reassembles all found data segments into new service information according to the application association protocol, and returns the new service information and application links corresponding to each data segment in the new service information to the application association platform client. The application association platform client displays the received information on the interface of the application association platform client. Therefore, the user may view information such as the movie synopses, related movie reviews, and movie ticket prices of Jurassic World on the interface of the application association platform client of the terminal. In an exemplary embodiment, service information of each application is presented on the application association platform client in a search manner, and the service information and a source of the service information are rapidly found on the application association platform, so as to improve the search efficiency of the service information.

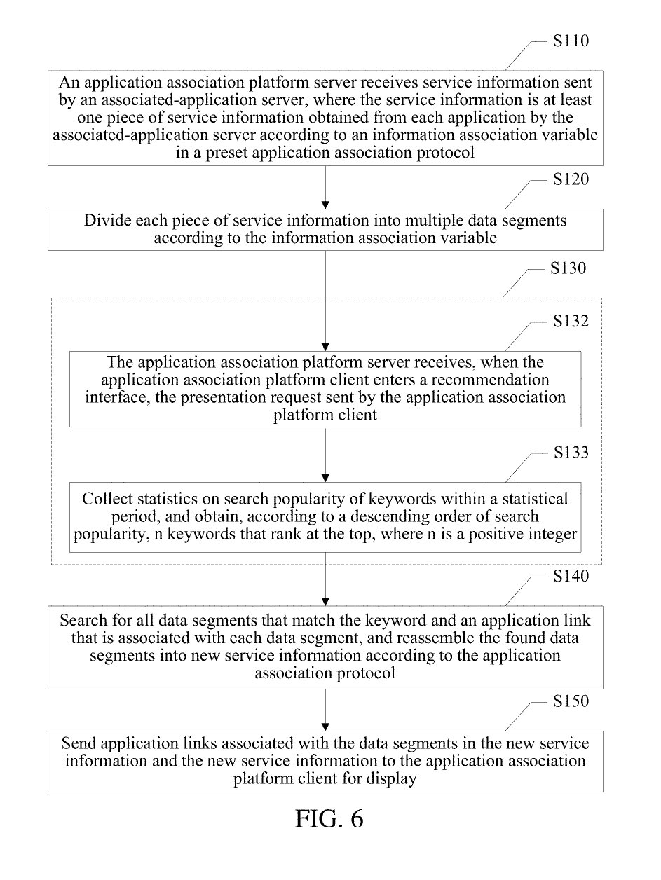

FIG. 6 is a flowchart of a method for associating application service information implemented by an application association platform server according to another exemplary embodiment. This embodiment includes operations of the embodiment shown in FIG. 3, in which Operation S130 further includes:

Operation S132: in an exemplary embodiment, upon an application association platform client enters a recommendation interface, the application association platform server receives a presentation request sent by the application association platform client.

Operation S133: in an exemplary embodiment, the application association platform server collects statistics on search popularity of keywords within a statistical period, and obtains n keywords that rank at the top according to a descending order of search popularity, where n is a positive integer.

In an exemplary embodiment, as shown in FIG. 14b, the application association platform server collects statistics on search popularity of the keywords in advance within a statistical period (for example, a week, a month, or a season). For example, in a recent week, movies “Jurassic World”, “San Andreas”, and “Doraemon” are on show. Therefore, the three keywords “Jurassic World”, “San Andreas”, and “Doraemon” have relatively high search popularity. When opening a home page or entering a recommendation page of each category, the application association platform client automatically initiates a presentation request to the application association platform server, and the presentation request does not include a keyword. After receiving the presentation request sent by the client, the application association platform server automatically obtains the three keywords that have been collected, and searches for all matched data segments according to the three popular keywords, including: movie synopses, pictures, ticket prices, and the like, and application links of an application A, an application B, and an application C corresponding to each data segment. In an exemplary embodiment, the application association platform server reassembles all found data segments into new service information according to the application association protocol, and returns the new service information and application links corresponding to each data segment in the new service information to the application association platform client. The application association platform client displays the received information on the interface of the application association platform client. In an exemplary embodiment, a recommendation content may further be displayed by category. For example, FIG. 14b shows a movie ticket category and a coupon category. Recommendation information of the movie ticket category and recommendation information of the coupon category are displayed in home page recommendation. If the user only selects the coupon category for specific display, the current page only displays the recommendation information of the coupon category. The recommendation manner is consistent with the foregoing recommendation manner of the movie ticket category. A keyword is obtained from popular coupons or popular applications, and a matched data segment is found and displayed on the application association platform client. In an exemplary embodiment, recommended service information automatically generated on the application association platform is presented, so as to simplify an operation process of searching for service information and a source of the service information on the application association platform, thereby improving the response efficiency of an application corresponding to target service information.

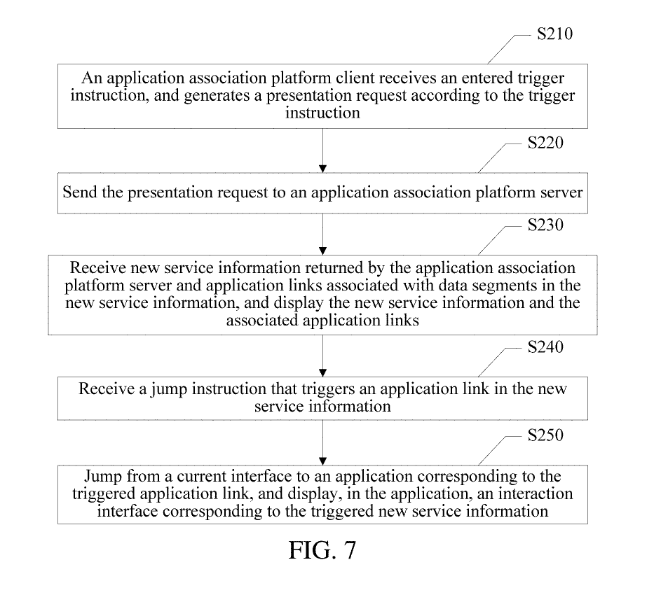

FIG. 7 is a flowchart of a method for associating application service information implemented by an application association platform client according to an exemplary embodiment. The method comprises the following operations:

Operation S210: in an exemplary embodiment, the application association platform client receives an entered trigger instruction, and generates a presentation request according to the trigger instruction.

Operation S220: in an exemplary embodiment, the application association platform client sends the presentation request to an application association platform server.

In an exemplary embodiment, the application association platform client is used to implement the method for associating application service information. When a user opens an application association platform client on a terminal, the application association platform client enters a home page recommendation interface. In this case, the application association platform client may automatically generate a presentation request that does not include a keyword. If the user enters a keyword into a search bar of the application association platform client, the application association platform client may automatically generate a presentation request that includes the keyword. The application association platform client sends the generated presentation request to the application association platform server through a network of the terminal.

Operation S230: in an exemplary embodiment, the application association platform client receives new service information returned by the application association platform server and application links associated with data segments in the new service information, and display the new service information and the associated application links.

In an exemplary embodiment, after receiving the presentation request, the application association platform server obtains the keyword according to the presentation request. If the presentation request is generated according to search information entered by the user, the presentation request includes a search keyword entered by the user. If the presentation request is a presentation instruction initiated by the client, the application association platform server may automatically filter out a popular keyword according to search popularity. The application association platform server searches, according to the keyword, for a corresponding data segment and an application link associated with the found data segment.

In an exemplary embodiment, as shown in FIG. 13, all data segments, that is, a name A, a picture A, and a video A, and links of the application A and the application B associated with these data segments are found according to a keyword A. The application association platform server reassembles the obtained data segments according to the application association protocol to obtain new service information, and forms new interface data by using the new service information and application links associated with the data segments in the new service information. As shown in FIG. 13, the data segments, that is, the name A, the picture A, and the video A in the service information A, an application link application A associated with the name A and the picture A, and an application link application B associated with the name A and the video A are reassembled to form new service information.

In an exemplary embodiment, the application association platform server sends the reassembled service information and the related application links together to the application association platform client, and the application association platform client displays the received information on an interaction interface of the application association platform client for users to view.

In an exemplary embodiment, as shown in FIG. 14a, assuming that a keyword included in a presentation request is “movie Jurassic World”, matched data segments found by an application association platform include movie synopses, pictures, movie ticket prices and movie reviews in the application A and the application B of Jurassic World, and application links of the application A and the application B associated with these data segments. In an exemplary embodiment, the application association platform reassembles the found information and displays the information on an interaction interface of the application association platform client. A user may directly find, in the application association platform client, which applications service information needed by the user is specifically on.

Operation S240: in an exemplary embodiment, the application association platform client receives a jump instruction that triggers an application link in the new service information.

Operation S250: in an exemplary embodiment, the application association platform client jumps from a current interface to an application corresponding to the triggered application link, and displays, in the application, an interaction interface corresponding to the triggered new service information.

In an exemplary embodiment, when viewing the needed service information, a user may click the service information or a label in the service information. The label is corresponding to a data segment. In this case, a jump instruction is generated, and the clicked label is the application link triggered in this embodiment. When detecting that the application link is triggered, the application association platform client may directly invoke an application that is corresponding to the application link and is on the terminal, jump from a currently displayed interface of the application association platform client to an application interaction interface corresponding to the triggered application link, search for corresponding service information in a currently running application according to the clicked new service information, and display, on the currently running application, an interaction interface corresponding to the service information, so as to implement a fast jump to the application. In an exemplary embodiment, as shown in FIG. 14a, there are ticket labels of the application A and the application B. The ticket labels are associated with corresponding application links. When a user intends to enter the application A to purchase a ticket, the user only needs to click the ticket label of the application A, content currently displayed on the terminal may jump from the current interface to an interaction interface of the application A, and directly jump to a ticket interface of the movie Jurassic World in the application A. In an exemplary embodiment, after the application link displayed on the interface of the application association platform client is triggered, a jump may be directly made from the application association platform client to the triggered application, and navigation to an interaction interface of target service information in the application may be directly performed, so as to implement a fast jump to the application. Therefore, the user does not need to manually start the application to jump to, thereby simplifying an operation process of manually searching for an application and service information in the application and further reducing a search time for the service information.

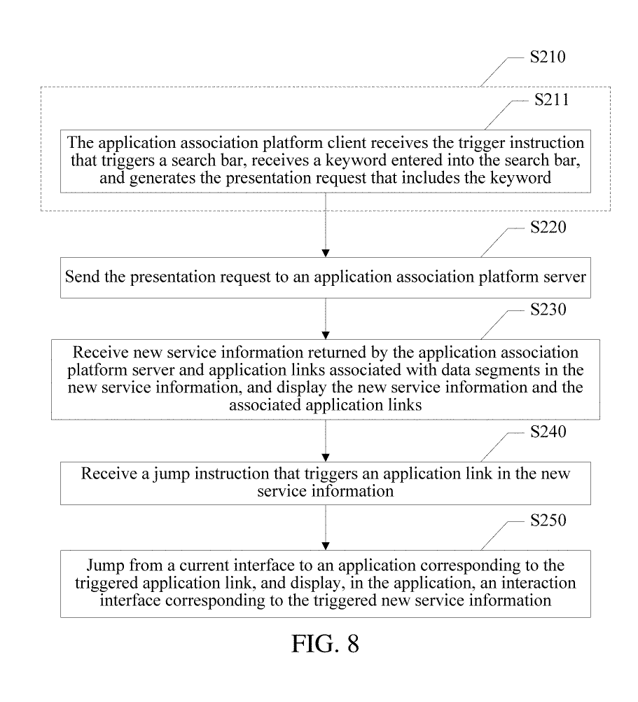

FIG. 8 is a flowchart of a method for associating application service information implemented by an application association platform client according to another exemplary embodiment. The method comprises the operations of the embodiment shown in FIG. 7, in which Operation S210 further includes:

Operation S211: in an exemplary embodiment, the application association platform client receives a trigger instruction that triggers a search bar, receives a keyword entered into the search bar, and generates a presentation request that includes the keyword.

In an exemplary embodiment, as shown in FIG. 14a, when the user enters a keyword “movie Jurassic World” into a search bar of an interface of the application association platform client, the application association platform client encapsulates the keyword into a presentation request, and sends the presentation request to the application association platform server. The application association platform server extracts the keyword from the presentation request, and searches for all data segments that match the keyword, including: movie synopses, pictures, movie ticket prices and movie reviews in the application A and the application B of Jurassic World, and an application link corresponding to each data segment, including: application links of the application A and the application B. In an exemplary embodiment, the application association platform server further reassembles all found data segments into new service information according to the application association protocol, and returns the new service information and the application links corresponding to each data segment in the new service information to the application association platform client. In an exemplary embodiment, the application association platform client displays the received information on the interface of the application association platform client. Therefore, the user may view information such as the movie synopses, related movie reviews, and movie ticket prices of Jurassic World on the interface of the application association platform client of the terminal. In an exemplary embodiment, service information of each application is presented on the application association platform client in a search manner, and the service information and a source of the service information are rapidly found on the application association platform, so as to help improve the search efficiency of the service information.

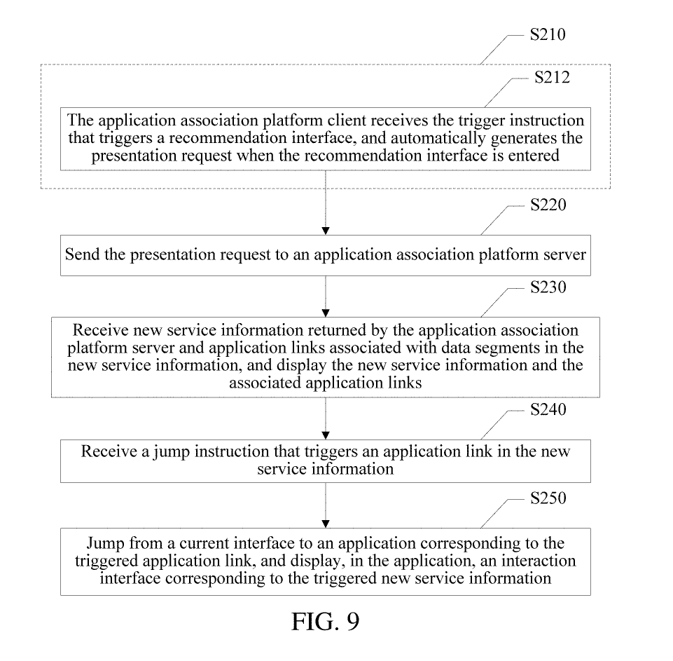

FIG. 9 is a flowchart of a method for associating application service information implemented by an application association platform client according to another exemplary embodiment. The method comprises the operations of the embodiment shown in FIG. 7, in which Step S210 further includes:

Operation S212: in an exemplary embodiment, the application association platform client receives a trigger instruction that triggers a recommendation interface, and automatically generates a presentation request in response to that the recommendation interface is entered.

In an exemplary embodiment, as shown in FIG. 14b, the application association platform server collects statistics on search popularity of keywords in advance within a statistical period (for example, a week, a month, or a season). For example, in a recent week, movies “Jurassic World”, “San Andreas”, and “Doraemon” are on show. Therefore, the three keywords “Jurassic World”, “San Andreas”, and “Doraemon” have relatively high search popularity. When opening a home page or entering a recommendation page of each category, the application association platform client automatically initiates a presentation request to the application association platform server, and the presentation request does not include a keyword. After receiving the presentation request sent by the client, the application association platform server automatically obtains the three keywords that have been collected, and searches for all matched data segments according to the three popular keywords, including: movie synopses, pictures, ticket prices, and the like, and application links of an application A, an application B, and an application C corresponding to each data segment. In an exemplary embodiment, the application association platform server reassembles all found data segments into new service information according to the application association protocol, and returns the new service information and application links corresponding to each data segment in the new service information to the application association platform client. The application association platform client displays the received information on the interface of the application association platform client. In an exemplary embodiment, a recommendation content may further be displayed by category. For example, FIG. 14b shows a movie ticket category and a coupon category. Recommendation information of the movie ticket category and recommendation information of the coupon category are displayed in home page recommendation. If a user only selects the coupon category for specific display, the current page only displays the recommendation information of the coupon category. The recommendation manner is consistent with the foregoing recommendation manner of the movie ticket category. A keyword is obtained from popular coupons or popular applications, and a matched data segment is found and displayed on the application association platform client. In an exemplary embodiment, recommended service information is automatically generated on the application association platform and presented, so as to simplify an operation process of searching for service information and a source of the service information on the application association platform, thereby improving the response efficiency of an application corresponding to target service information.

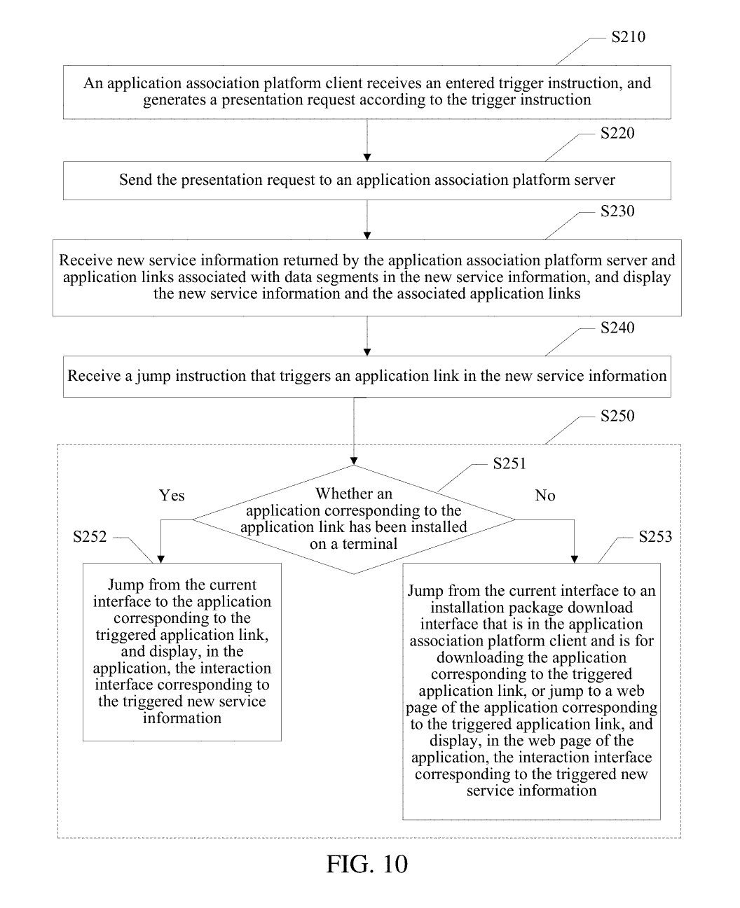

FIG. 10 is a flowchart of a method for associating application service information implemented by an application association platform client according to another exemplary embodiment. The method comprises the operations of the embodiment shown in FIG. 7, in which Operation S250 further includes the following operations:

Operation S251: in an exemplary embodiment, the application association platform client determines whether an application corresponding to the application link has been installed in a terminal in which the application association platform client is located. If the application corresponding to the application link has been installed in the terminal, the application association platform client performs Operation S252. If the application corresponding to the application link has not been installed in the terminal, the application association platform client performs Operation S253.

Operation S252: in an exemplary embodiment, the application association platform client jumps from a current interface to an application corresponding to the triggered application link, and displays, in the application, an interaction interface corresponding to the triggered new service information.

Operation S253: in an exemplary embodiment, the application association platform client jumps from a current interface to an installation package download interface that is in the application association platform client and is for downloading the application corresponding to the triggered application link, or jumps to a web page of the application corresponding to the triggered application link, and displays, in the web page of the application, an interaction interface corresponding to the triggered new service information.

In an exemplary embodiment, the application associated with the new service information displayed on the interface of the application association platform client may have not been installed in the current terminal. When an application link is triggered, the terminal cannot directly jump to the interface of the application that is not installed. In this case, the application association platform may download an installation package of the application in advance from the server (that is, an associated-application server) of the application, or obtain an installation package download address of the application from the server of the application. When the application association platform client detects that the application corresponding to the triggered application link has not been installed in the current terminal, the application association platform client jumps from the current interface to an installation package download interface of the application to be installed. If the application association platform server has downloaded the installation package of the application in advance, the installation package download interface may be an interface that is on the application association platform client and that is used to download the installation package of the application. If the application association platform server has not downloaded the installation package of the application, but only obtains the installation package download address of the application, the installation package download interface may be a web page that is corresponding to the download address and to which the application association platform client jumps or another application download interface. In an exemplary embodiment, if the application not only has its own application client but also has a web version, a browser of the terminal may further be invoked to enter a web page of the application, and an interaction interface corresponding to the triggered new service information is displayed on the web page of the application. In this way, when the application to jump to has been installed on the current terminal, the application association platform client may implement a fast jump to the application. If the application to jump to has not been installed in the current terminal, the application association platform client jumps to the installation package download interface of the application or the web page of the application, so as to simplify an operation process of searching for an installation package of an application or a web page by a user, and improve efficiency of installing or jumping to the application.

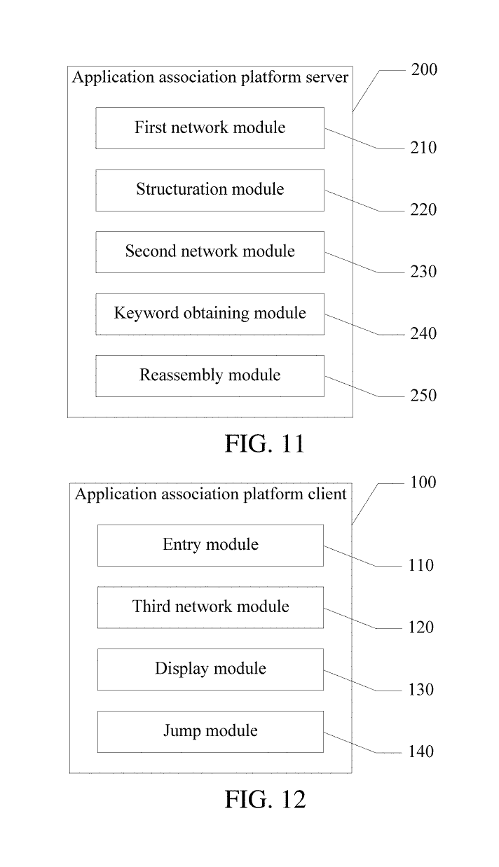

FIG. 11 is a schematic diagram of modules of an application association platform server according to an exemplary embodiment. The application association platform server 200 includes: a first network module 210 configured to receive service information sent by an associated-application server, where the service information comprises at least one piece of service information obtained from each application by the associated-application server according to an information association variable in a preset application association protocol; a structuration module 220 configured to divide each piece of service information into a plurality of data segments according to the information association variable; a second network module 230 configured to receive a presentation request sent by an application association platform client; a keyword obtaining module 240 configured to obtain a keyword according to the presentation request; and a reassembly module 250 configured to search for all data segments that match the keyword and application links that are associated with each data segment, and to reassemble the found data segments into new service information according to the application association protocol.

In an exemplary embodiment, the second network module 230 is further configured to send the new service information and application links associated with the data segments in the new service information to the application association platform client for display.

In an exemplary embodiment, the application association platform server is used to implement the method for associating application service information. The application association platform server may record service information of various applications, and display the service information on the interface of the application association platform client. In an exemplary embodiment, the server corresponding to various applications is the associated-application server. An application association protocol is preset between the application association platform server and the associated-application server. The application association protocol includes multiple information association variables, and the information association variables are related to the service information in the applications and include a name, a category, a picture, audio, a video, a keyword, a data and time of creation, last modification and the like involved in the service information. The associated-application server extracts some or all of the service information from the applications according to the information association variables in the application association protocol. The service information includes content corresponding to the information association variables.

In an exemplary embodiment, an application A includes service information such as “movie tickets”, “movie reviews”, “coupons”, and “videos”, the associated-application server extracts information such as names, synopses, pictures, ticket prices, and ratings from the service information “movie tickets” according to the information association variables in the application association protocol, and further extracts information such as titles and plot synopses from the service information “movie reviews”. Each associated-application server sends the extracted service information to an application association platform, and the service information is associated with an application of the associated-application server. In an exemplary embodiment, as shown in FIG. 13, according to the information association variables, such as names, pictures, and videos, the application A provides service information A and service information B to the application association platform, and an application B provides service information A to the application association platform.

In an exemplary embodiment, the application association platform divides each piece of service information according to the information association variable, to form structured data segments. During division, each piece of service information may further be pre-processed. For example, repetitive data is removed, associated data is combined into a same item, and content that violates legal or ethical norms is filtered out. In an exemplary embodiment, as shown in FIG. 13, the service information A provided by the application A is divided into a name A and a picture A; the service information B provided by the application A is divided into a name B, a picture B, and a video B; and the service information A provided by the application B is divided into the name A and a video A. After the service information A provided by the application A and the service information A provided by the application B are divided, there is some repetitive content, that is, the data segment “name A”, and there is associated content, that is, the picture A and the video A that are both associated with the name A. Therefore, repetitive data may be removed, and the name A, the picture A, and the video A may be combined into one item.

In an exemplary embodiment, the application association platform client is installed in a terminal in advance. The application association platform client includes a browser or a client that supports an application association function. The browser and the client both support the application association protocol provided by the application association platform.

In an exemplary embodiment, in response to that a user opens the application association platform client on the terminal, the application association platform client may generate a presentation request according to search information entered by the user, or initiate a presentation instruction, and send the presentation request to the application association platform server. If the presentation request is generated according to the search information entered by the user, the presentation request includes a search keyword entered by the user. If the presentation instruction is initiated by the client, the application association platform server may automatically filter out a popular keyword according to search popularity.

In an exemplary embodiment, the application association platform server searches, according to a keyword, for a corresponding data segment and an application link associated with the found data segment. In an exemplary embodiment, as shown in FIG. 13, all data segments, that is, a name A, a picture A, and a video A, and links of the application A and the application B associated with these data segments are found according to a keyword A.

In an exemplary embodiment, the application association platform server reassembles the obtained data segments according to the application association protocol to obtain new service information, and forms new interface data by using the new service information and application links associated with the data segments in the new service information.

In an exemplary embodiment, as shown in FIG. 13, the data segments, that is, the name A, the picture A, and the video A in the service information A, an application link application A associated with the name A and the picture A, and an application link application B associated with the name A and the video A are reassembled to form new service information.

In an exemplary embodiment, the application association platform server sends the reassembled service information and the related application links together to the application association platform client. In an exemplary embodiment, the application association platform client displays the received information on an interaction interface of the application association platform client for users to view.

In an exemplary embodiment, as shown in FIG. 14a, a keyword included in a presentation request is “movie Jurassic World”, matched data segments found by an application association platform include movie synopses, pictures, movie ticket prices and movie reviews in the application A and the application B of Jurassic World, and application links of the application A and the application B associated with these data segments. In an exemplary embodiment, the application association platform reassembles the found information and displays the information on an interaction interface of the application association platform client. A user may directly find, in the application association platform client, which applications service information needed by the user is specifically on, thereby simplifying an operation process of searching an application for service information and reducing a search time.

In an exemplary embodiment, the application association platform server presets an application association protocol, obtains service information in each application from an associated-application server according to an information association variable specified in the application association protocol, and divides the service information into a plurality of data segments according to the information association variable in the application association protocol. When a presentation request sent by an application association platform client is received, a corresponding data segment is found according to a keyword included in the presentation request, and the found data segment and an application link corresponding to the data segment are reassembled according to the application association protocol, returned to the application association platform client, and displayed on an interface of the application association platform client by the application association platform client. A user may directly find, in the application association platform client, which applications service information needed by the user is specifically on, thereby simplifying an operation process of searching an application for service information and reducing a search time.

In an exemplary embodiment, the first network module 210 as shown in FIG. 11 is further configured to: receive an application association request sent by an associated-application server; and send a preset application association protocol to the associated-application server, where the application association protocol includes multiple information association variables.

In an exemplary embodiment, the application association platform server generates an application association protocol in advance according to an information association variable entered by a developer. The application association protocol includes multiple information association variables, and the information association variables are related to service information in the applications and include a name, a category, a picture, audio, a video, a keyword, a data and time of creation, last modification and the like involved in the service information. When an associated-application server needs to associate some applications to the application association platform, the associated-application server may actively send an application association request to the application association platform server. After receiving the request, the application association platform server returns the preset application association protocol to the associated-application server. Next, the associated-application server may obtain, according to an information association variable in the application association protocol, information needed by the application association platform server, that is, service information in each application.

In an exemplary embodiment, the application association platform server obtains service information from the associated-application server according to the application association protocol and the information association variable, so that the application association platform server subsequently divides the obtained service information into multiple data segments, and associates each application link with a corresponding data segment, so as to facilitate implementation of reassembly of service information.

In an exemplary embodiment, the second network module 230 as shown in FIG. 11 is further configured to receive a presentation request that includes a keyword and is sent by the application association platform client, where the keyword is a keyword that is entered into a search bar and is received by the application association platform client.

In an exemplary embodiment, the keyword obtaining module 240 as shown in FIG. 11 is further configured to extract the keyword from the presentation request.

In an exemplary embodiment, as shown in FIG. 14a, when the user enters a keyword “movie Jurassic World” into a search bar of an interface of the application association platform client, the application association platform client encapsulates the keyword into a presentation request, and sends the presentation request to the application association platform server. The application association platform server extracts the keyword from the presentation request, and searches for all data segments that match the keyword, including: movie synopses, pictures, movie ticket prices and movie reviews in the application A and the application B of Jurassic World, and an application link corresponding to each data segment, including: application links of the application A and the application B. The application association platform server further reassembles all found data segments into new service information according to the application association protocol, and returns an application link corresponding to each data segment in the new service information and the new service information together to the application association platform client. The application association platform client displays the received information on the interface of the application association platform client. Therefore, the user may view information such as the movie synopses, related movie reviews, and movie ticket prices of Jurassic World on the interface of the application association platform client of the terminal. In an exemplary embodiment, service information of each application is presented on the application association platform client in a search manner, and the service information and a source of the service information are rapidly found on the application association platform, so as to improve the search efficiency of the service information.

In an exemplary embodiment, the second network module 230 as shown in FIG. 11 is further configured to receive the presentation request sent by the application association platform client, in response to that the application association platform client enters a recommendation interface.

In an exemplary embodiment, the keyword obtaining module 240 as shown in FIG. 11 is further configured to: collect statistics on search popularity of keywords within a statistical period, and obtain n keywords that rank at the top according to a descending order of search popularity, where n is a positive integer.

In an exemplary embodiment, referring to FIG. 14b, the application association platform server collects statistics on search popularity of keywords in advance within a statistical period (for example, a week, a month, or a season). For example, in a recent week, movies “Jurassic World”, “San Andreas”, and “Doraemon” are on show. Therefore, the three keywords “Jurassic World”, “San Andreas”, and “Doraemon” have relatively high search popularity. When opening a home page or entering a recommendation page of each category, the application association platform client automatically initiates a presentation request to the application association platform server, and the presentation request does not include a keyword. After receiving the presentation request sent by the client, the application association platform server automatically obtains the three keywords that have been collected, and searches for all matched data segments according to the three popular keywords, including: movie synopses, pictures, ticket prices, and the like, and application links of an application A, an application B, and an application C corresponding to each data segment. In an exemplary embodiment, the application association platform server reassembles all found data segments into new service information according to the application association protocol, and returns an application link corresponding to each data segment in the new service information and the new service information together to the application association platform client. The application association platform client displays the received information on the interface of the application association platform client. In an exemplary embodiment, recommendation content may further be displayed by category. For example, FIG. 14b shows a movie ticket category and a coupon category. Recommendation information of the movie ticket category and recommendation information of the coupon category are displayed in home page recommendation. If the user only selects the coupon category for specific display, the current page only displays the recommendation information of the coupon category. The recommendation manner is consistent with the foregoing recommendation manner of the movie ticket category. A keyword is obtained from popular coupons or popular applications, and a matched data segment is found and displayed on the application association platform client. In an exemplary embodiment, recommended service information is automatically generated on the application association platform and presented, so as to simplify an operation process of searching for service information and a source of the service information on the application association platform, thereby improving the response efficiency of an application corresponding to target service information.

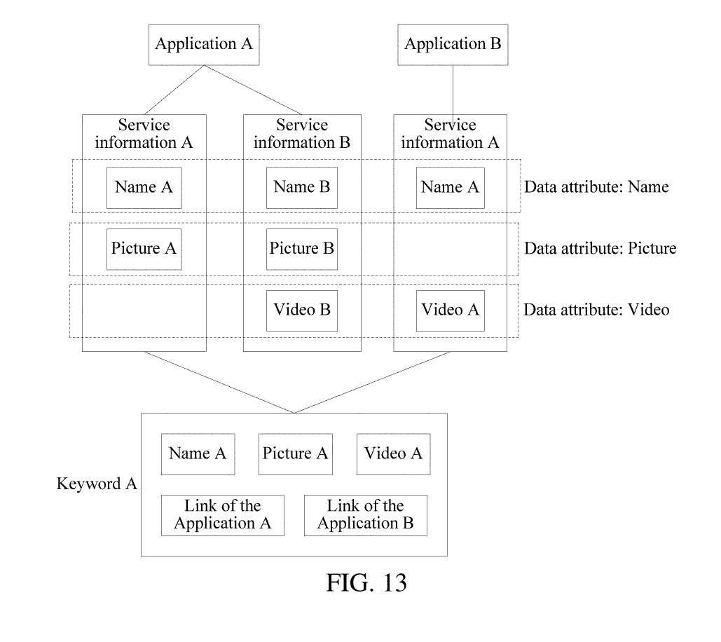

FIG. 12 is a schematic diagram of modules of an application association platform client 100 according to an exemplary embodiment. The application association platform client 100 includes: an entry module 110 configured to receive an entered trigger instruction, and generate a presentation request according to the trigger instruction; a third network module 120 configured to send the presentation request to an application association platform server and receive new service information returned by the application association platform server and application links associated with data segments in the new service information; a display module 130 configured to display the new service information and the associated application links; and a jump module 140 configured to jump from a current interface to an application corresponding to the triggered application link.

In an exemplary embodiment, the entry module 110 is further configured to receive a jump instruction that triggers an application link in the new service information. In an exemplary embodiment, the display module 130 is further configured to display, in the application, an interaction interface corresponding to the triggered new service information.

In an exemplary embodiment, the application association platform client is used to implement the method for associating application service information. When a user opens an application association platform client on a terminal, the application association platform client enters a home page recommendation interface. In this case, the application association platform client may automatically generate a presentation request that does not include a keyword. If the user enters a keyword into a search bar of the application association platform client, the application association platform client may automatically generate a presentation request that includes the keyword. The application association platform client sends the generated presentation request to the application association platform server through a network of the terminal.

In an exemplary embodiment, after receiving a presentation request, the application association platform server obtains a keyword according to the presentation request. If the presentation request is generated according to search information entered by the user, the presentation request includes a search keyword entered by the user. If the presentation request is a presentation instruction initiated by the client, the application association platform server may automatically filter out a popular keyword according to search popularity. The application association platform server searches, according to the keyword, for a corresponding data segment and an application link associated with the found data segment.

In an exemplary embodiment, as shown in FIG. 13, all data segments, that is, a name A, a picture A, and a video A, and links of the application A and the application B associated with these data segments are found according to a keyword A. In an exemplary embodiment, the application association platform server reassembles the obtained data segments according to the application association protocol to obtain new service information, and forms new interface data by using the new service information and application links associated with the data segments in the new service information. In an exemplary embodiment, as shown in FIG. 13, the data segments, that is, the name A, the picture A, and the video A in the service information A, an application link application A associated with the name A and the picture A, and an application link application B associated with the name A and the video A are reassembled to form new service information.

In an exemplary embodiment, the application association platform server sends the reassembled service information and the related application links together to the application association platform client. In an exemplary embodiment, the application association platform client displays the received information on an interaction interface of the application association platform client for users to view.

In an exemplary embodiment, as shown in FIG. 14a, a keyword included in a presentation request is “movie Jurassic World”, matched data segments found by an application association platform include movie synopses, pictures, movie ticket prices and movie reviews in the application A and the application B of Jurassic World, and application links of the application A and the application B associated with these data segments, and the application association platform reassembles the found information and displays the information on an interaction interface of the application association platform client. A user may directly find, in the application association platform client, which applications service information needed by the user is specifically on.

In an exemplary embodiment, when viewing the service information needed by a user, the user may click the service information or a label in the service information. The label corresponds to a data segment. In this case, a jump instruction is generated, and the clicked label is the application link triggered in this embodiment. When detecting that the application link is triggered, the application association platform client may directly invoke an application that is corresponding to the application link and is on the terminal, jump from a currently displayed interface of the application association platform client to an application interaction interface corresponding to the triggered application link, search for corresponding service information in a currently running application according to the clicked new service information, and display, on the currently running application, an interaction interface corresponding to the service information, so as to implement a fast jump to the application. In an exemplary embodiment, as shown in FIG. 14a, there are ticket labels of the application A and the application B. The ticket labels are associated with corresponding application links. When a user intends to enter the application A to purchase a ticket, the user only needs to click the ticket label of the application A, content currently displayed on the terminal may jump from the current interface to an interaction interface of the application A, and directly jump to a ticket interface of the movie Jurassic World in the application A. In an exemplary embodiment, after the application link displayed on the interface of the application association platform client is triggered, a jump may be directly made from the application association platform client to the triggered application, and navigation to an interaction interface of target service information in the application may be directly performed, so as to implement a fast jump to the application. Therefore, the user does not need to manually start the application to jump to, thereby simplifying an operation process of manually searching for an application and service information in the application and further reducing a search time for the service information.

In an exemplary embodiment, the entry module 110 as shown in FIG. 12 is further configured to receive a trigger instruction that triggers a search bar, receive a keyword entered into the search bar, and generate the presentation request that includes the keyword. In an exemplary embodiment, as shown in FIG. 14a, when the user enters a keyword “movie Jurassic World” into a search bar of an interface of the application association platform client, the application association platform client encapsulates the keyword into a presentation request, and sends the presentation request to the application association platform server. The application association platform server extracts the keyword from the presentation request, and searches for all data segments that match the keyword, including: movie synopses, pictures, movie ticket prices and movie reviews in the application A and the application B of Jurassic World, and an application link corresponding to each data segment, including: application links of the application A and the application B. In an exemplary embodiment, the application association platform server further reassembles all found data segments into new service information according to the application association protocol, and returns the new service information and application links corresponding to each data segment in the new service information to the application association platform client. In an exemplary embodiment, the application association platform client displays the received information on the interface of the application association platform client. Therefore, the user may view information such as the movie synopses, related movie reviews, and movie ticket prices of Jurassic World on the interface of the application association platform client of the terminal. In this embodiment, service information of each application is presented on the application association platform client in a search manner, and the service information and a source of the service information are rapidly found on the application association platform, so as to improve the search efficiency of the service information.

In an exemplary embodiment, the entry module 110 as shown in FIG. 12 is further configured to receive a trigger instruction that triggers a recommendation interface, and automatically generate a presentation request in response to that the recommendation interface is entered.

In an exemplary embodiment, as shown in FIG. 14b, the application association platform server collects statistics on search popularity of keywords in advance within a statistical period (for example, a week, a month, or a season). For example, in a recent week, movies “Jurassic World”, “San Andreas”, and “Doraemon” are on show. Therefore, the three keywords “Jurassic World”, “San Andreas”, and “Doraemon” have relatively high search popularity. When opening a home page or entering a recommendation page of each category, the application association platform client automatically initiates a presentation request to the application association platform server, and the presentation request does not include a keyword. In an exemplary embodiment, after receiving a presentation request sent by the client, the application association platform server automatically obtains the three keywords that have been collected, and searches for all matched data segments according to the three popular keywords, including: movie synopses, pictures, ticket prices, and the like, and application links of an application A, an application B, and an application C corresponding to each data segment. In an exemplary embodiment, the application association platform server reassembles all found data segments into new service information according to the application association protocol, and returns an application link corresponding to each data segment in the new service information and the new service information together to the application association platform client. The application association platform client displays the received information on the interface of the application association platform client. In and exemplary embodiment, a recommendation content may further be displayed by category. For example, FIG. 14b shows a movie ticket category and a coupon category. Recommendation information of the movie ticket category and recommendation information of the coupon category are displayed in home page recommendation. If the user only selects the coupon category for specific display, the current page only displays the recommendation information of the coupon category. The recommendation manner is consistent with the foregoing recommendation manner of the movie ticket category. A keyword is obtained from popular coupons or popular applications, and a matched data segment is found and displayed on the application association platform client. In this embodiment, recommended service information automatically generated on the application association platform is presented, so as to help further simplify an operation process of searching for service information and a source of the service information on the application association platform, thereby improving the response efficiency of an application corresponding to target service information.

In an exemplary embodiment, the jump module 140 as shown in FIG. 12 is further configured to: determine whether an application corresponding to the application link has been installed in a terminal in which the application association platform client is located. In an exemplary embodiment, if the application corresponding to the application link has been installed in the terminal, the jump module 140 jumps from a current interface to an application corresponding to the triggered application link, and displays, in the application, the interaction interface corresponding to the triggered new service information. On the other hand, if the application corresponding to the application link has not been installed in the terminal, the jump module 140 jumps from the current interface to an installation package download interface that is in the application association platform client and is for downloading the application corresponding to the triggered application link, or jumps to a web page of the application corresponding to the triggered application link, and displays, in the web page of the application, the interaction interface corresponding to the triggered new service information.

In an exemplary embodiment, the application associated with the new service information displayed on the interface of the application association platform client may have not been installed in the current terminal. When the application link is triggered, the terminal cannot directly jump to the interface of the application that is not installed. In this case, the application association platform may download an installation package of the application in advance from the server (that is, an associated-application server) of the application, or obtain an installation package download address of the application from the server of the application. In an exemplary embodiment, when the application association platform client detects that the application corresponding to the triggered application link has not been installed in a current terminal, the application association platform client jumps from the current interface to an installation package download interface of the application to be installed. If the application association platform server has downloaded the installation package of the application in advance, the installation package download interface may be an interface that is on the application association platform client and that is used to download the installation package of the application. If the application association platform server has not downloaded the installation package of the application, but only obtains the installation package download address of the application, the installation package download interface may be a web page that is corresponding to the download address and to which the application association platform client jumps or another application download interface. In an exemplary embodiment, if the application not only has its own application client but also has a web version, a browser of the terminal may further be invoked to enter a web page of the application, and an interaction interface corresponding to the triggered new service information is displayed on the web page of the application. In this way, when the application to jump to has been installed on the current terminal, the application association platform client may implement a fast jump to the application. If the application to jump to has not been installed on the current terminal, the application association platform client jumps to the installation package download interface of the application or the web page of the application, so as to help simplify an operation process of searching for an installation package of an application or a web page by a user, and improve the efficiency of installing or jumping to the application.

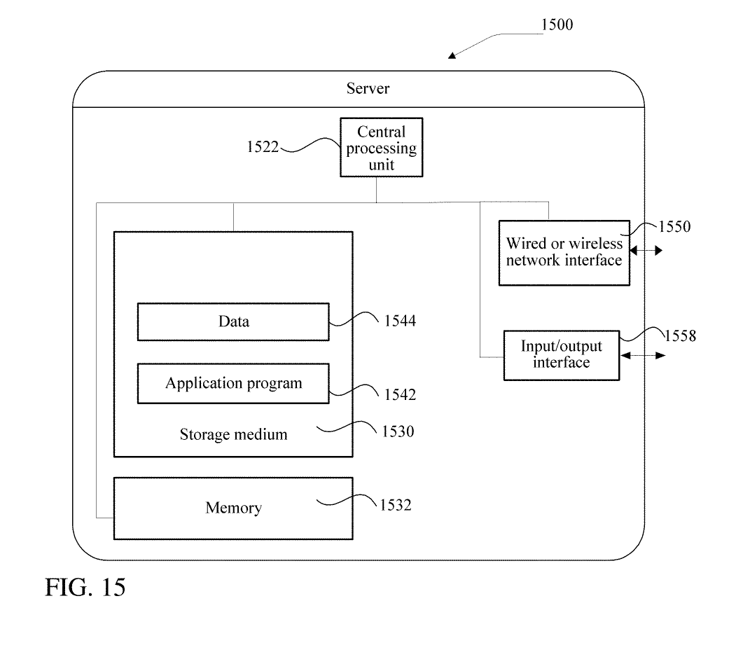

FIG. 15 is a schematic structural diagram of a server according to an exemplary embodiment. The server 1500 may vary greatly due to different configurations or performance, and may include one or more central processing units (CPUs) 1522 (for example, one or more processors), a memory 1532, and one or more storage media 1530 (for example, one or more mass storage devices) that store application programs 1542 or data 1544. Storage of the memory 1532 and the storage medium 1530 may be transient or persistent storage. A program stored in the storage medium 1530 may include one or more modules (not shown in the figure), and each module may include a series of instructions and operations in the server. Further, the CPU 1522 may be set to communicate with the storage medium 1530, and perform, on the server 1500, a series of instructions and operations in the storage medium 1530.

The server 1500 may further include one or more wired or wireless network interfaces 1550, one or more input/output interfaces 1558, and the like.

It should be noted that, the terms “includes”, “include”, and any variants thereof herein are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the object, or the device that includes the element.

The sequence numbers of the foregoing embodiments of the present invention are merely for the convenience of description, and do not imply the preference among the embodiments.

Through the above description of the implementation manners, a person skilled in the art may clearly understand that the method of the foregoing embodiment may be accomplished through software plus a necessary universal hardware platform or certainly through hardware, but in most cases, the former one is the preferred implementation manner. Based on such an understanding, the technical solutions of the present disclosure or the part that makes contributions to the existing technology can be embodied in the form of a software product. The computer software product is stored in a non-volatile storage medium (for example, a ROM/RAM, a magnetic disk, or an optical disc), and includes several instructions for instructing a terminal device (which may be a mobile phone, a computer, a server, a network device, or the like) to perform the methods described in the embodiments of the present invention.

The foregoing descriptions are merely preferred embodiments of the present invention but are not intended to limit the patent scope of the present disclosure. Any equivalent modifications made to the structures or processes based on the content of the specification and the accompanying drawings of the present disclosure for direct or indirect use in other relevant technical fields shall also be encompassed in the patent protection scope of the present disclosure.

1-18. (canceled)

19. A method for associating application service information, comprising:
receiving, by an application association platform server, service information sent by an associated-application server, the service information comprising at least one piece of service information obtained from each application by the associated-application server according to an information association variable in a preset application association protocol;
dividing each piece of the at least one piece of service information into a plurality of data segments according to the information association variable;
receiving a presentation request sent by an application association platform client, and obtaining a keyword according to the presentation request;
searching for all data segments that match the keyword and application links that are associated with each data segment of the plurality of data segments, and reassembling the found data segments into new service information according to the application association protocol; and
sending the new service information and the application links associated with the data segments in the new service information to the application association platform client for display.

20. The method for associating application service information according to claim 19, further comprising:
receiving, by the application association platform server, an application association request sent by the associated-application server; and
sending the preset application association protocol to the associated-application server,
wherein the application association protocol comprises a plurality of information association variables.

21. The method for associating application service information according to claim 19, further comprising:
receiving, by the application association platform server, the presentation request that comprises the keyword and is sent by the application association platform client, wherein the keyword is a keyword that is entered into a search bar and is received by the application association platform client; and extracting the keyword from the presentation request; or
receiving, by the application association platform server, in response to that the application association platform client enters a recommendation interface, the presentation request sent by the application association platform client; collecting statistics on search popularity of keywords within a statistical period; and obtaining n keywords that rank at the top according to a descending order of search popularity, wherein n is a positive integer.

22. A method for associating application service information, comprising:
receiving, by an application association platform client, an entered trigger instruction, generating a presentation request according to the trigger instruction, and sending the presentation request to an application association platform server;
receiving new service information returned by the application association platform server and application links associated with data segments in the new service information, and displaying the new service information and the associated application links; and
receiving a jump instruction that triggers an application link in the new service information, jumping from a current interface to an application corresponding to the triggered application link, and displaying, in the application, an interaction interface corresponding to the triggered new service information.

23. The method for associating application service information according to claim 22, further comprising:
receiving, by the application association platform client, the trigger instruction that triggers a search bar, receiving a keyword entered into the search bar, and generating the presentation request that comprises the keyword; or
receiving, by the application association platform client, the trigger instruction that triggers a recommendation interface, and automatically generating the presentation request when the recommendation interface is entered.

24. The method for associating application service information according to claim 22, further comprising:
determining, by the application association platform client, whether an application corresponding to the application link has been installed in a terminal in which the application association platform client is located; and
jumping from the current interface and displaying the interaction interface corresponding to the triggered new service information in the application,
wherein the jumping further comprises:
a jumping to the application corresponding to the triggered application link, in response to that the application corresponding to the application link has been installed in the terminal, and
a jumping to an installation package download interface that is in the application association platform client and is for downloading the application corresponding to the triggered application link or a jumping to a web page of the application corresponding to the triggered application link, in response to that the application corresponding to the application link has not been installed in the terminal.

25. An application association platform server, comprising:
a first network module configured to receive service information sent by an associated-application server, the service information comprises at least one piece of service information obtained from each application by the associated-application server according to an information association variable in a preset application association protocol;
a structuration module configured to divide each piece of service information into a plurality of data segments according to the information association variable;
a second network module configured to receive a presentation request sent by an application association platform client;
a keyword obtaining module configured to obtain a keyword according to the presentation request; and
a reassembly module configured to search for all data segments that match the keyword and application links that are associated with each data segment of the plurality of data segments, and reassemble the found data segments into new service information according to the application association protocol,
wherein the second network module is further configured to send application links associated with the data segments in the new service information and the new service information to the application association platform client for display.

26. The application association platform server according to claim 25, wherein the first network module is further configured to:
receive an application association request sent by the associated-application server; and
send the preset application association protocol to the associated-application server,
wherein the application association protocol comprises a plurality of information association variables.

27. The application association platform server according to claim 25,
wherein the second network module is further configured to receive the presentation request that comprises the keyword and is sent by the application association platform client,
wherein the keyword is a keyword that is entered into a search bar and is received by the application association platform client, and
wherein the keyword obtaining module is further configured to extract the keyword from the presentation request.

28. The application association platform server according to claim 25,
wherein the second network module is further configured to receive the presentation request sent by the application association platform client, in response to that the application association platform client enters a recommendation interface, and
wherein the keyword obtaining module is further configured to collect statistics on search popularity of keywords within a statistical period, and obtain n keywords that rank at the top according to a descending order of search popularity, wherein n is a positive integer.

29. An application association platform client, comprising:
an entry module configured to receive an entered trigger instruction and generate a presentation request according to the trigger instruction;
a third network module configured to send the presentation request to an application association platform server, and receive new service information returned by the application association platform server and application links associated with data segments in the new service information;
a display module configured to display the new service information and the associated application links; and
a jump module configured to jump from a current interface to an application corresponding to the triggered application link,
wherein the entry module is further configured to receive a jump instruction that triggers an application link in the new service information, and
wherein the display module is further configured to display, in the application, an interaction interface corresponding to the triggered new service information.

30. The application association platform client according to claim 28, wherein the entry module is further configured to:
receive the trigger instruction that triggers a search bar, receive a keyword entered into the search bar, and generate the presentation request that comprises the keyword; or
receive the trigger instruction that triggers a recommendation interface, and automatically generate the presentation request when the recommendation interface is entered.

31. The application association platform client according to claim 28, wherein the jump module is further configured to:
determine whether an application corresponding to the application link has been installed in a terminal in which the application association platform client is located;
in response to determining that the application corresponding to the application link has been installed in the terminal, jump from the current interface to the application corresponding to the triggered application link, and display, in the application, the interaction interface corresponding to the triggered new service information; and
in response to determining that the application corresponding to the application link has not been installed in the terminal, jump from the current interface to an installation package download interface that is in the application association platform client and is for downloading the application corresponding to the triggered application link, or jump to a web page of the application corresponding to the triggered application link; and display, in the web page of the application, the interaction interface corresponding to the triggered new service information.

32. A non-volatile computer readable storage medium storing a program, the program causing a computer to perform:
receiving service information sent by an associated-application server, the service information comprising at least one piece of service information obtained from each application by the associated-application server according to an information association variable in a preset application association protocol;
dividing each piece of service information into a plurality of data segments according to the information association variable;
receiving a presentation request sent by an application association platform client, and obtaining a keyword according to the presentation request;
searching for all data segments that match the keyword and application links that are associated with each data segment of the plurality of data segments, and reassembling the found data segments into new service information according to the application association protocol; and
sending application links associated with the data segments in the new service information and the new service information to the application association platform client for display.

33. The non-volatile computer readable storage medium according to claim 31, wherein the program can further cause the computer to perform:
receiving an application association request sent by the associated-application server; and
sending the preset application association protocol to the associated-application server,
wherein the application association protocol comprises a plurality of information association variables.

34. The non-volatile computer readable storage medium according to claim 31, further comprising:
receiving, by the application association platform server, the presentation request that comprises the keyword and is sent by the application association platform client, wherein the keyword is a keyword that is entered into a search bar and is received by the application association platform client; and extracting the keyword from the presentation request; or
receiving, by the application association platform server when the application association platform client enters a recommendation interface, the presentation request sent by the application association platform client; and collecting statistics on search popularity of keywords within a statistical period, and obtaining, according to a descending order of search popularity, n keywords that rank at the top, wherein n is a positive integer.

35. A non-volatile computer readable storage medium storing a program, the program causing a computer to perform:
receiving an entered trigger instruction, generating a presentation request according to the trigger instruction, and sending the presentation request to an application association platform server;
receiving new service information returned by the application association platform server and application links associated with data segments in the new service information, and displaying the new service information and the associated application links; and
receiving a jump instruction that triggers an application link in the new service information, jumping from a current interface to an application corresponding to the triggered application link, and displaying, in the application, an interaction interface corresponding to the triggered new service information.

36. The non-volatile computer readable storage medium according to claim 34, further comprising:
receiving, by the application association platform client, the trigger instruction that triggers a search bar, receiving a keyword entered into the search bar, and generating the presentation request that comprises the keyword; or
receiving, by the application association platform client, the trigger instruction that triggers a recommendation interface, and automatically generating the presentation request when the recommendation interface is entered.

37. The non-volatile computer readable storage medium according to claim 34, further comprising:
determining, by the application association platform client, whether an application corresponding to the application link has been installed in a terminal in which the application association platform client is located; and
in response to determining that the application corresponding to the application link has been installed on the terminal, jumping from the current interface to the application corresponding to the triggered application link, and displaying, in the application, the interaction interface corresponding to the triggered new service information; and
in response to determining that the application corresponding to the application link has not been installed in the terminal, jumping from the current interface to an installation package download interface that is in the application association platform client and is for downloading the application corresponding to the triggered application link, or jumping to a web page of the application corresponding to the triggered application link, and displaying, in the web page of the application, the interaction interface corresponding to the triggered new service information.
